(19) United States
(12) Patent Application Publication
(10) Pub. No.: US 2002/0093147 A1
(43) Pub. Date: Jul. 18, 2002

(54) Well plate seal

(76) Inventors: Michael J. Berna, Noblesville, IN (US); Roger Q. Roberts, Laguna Niguel, CA (US); Robert L. Grenz, Santa Ana, CA (US); Roger R. Rohrdanz, Huntington Beach, CA (US)

Correspondence Address: Walter A. Hackler, Ph.D, Attorney of Record, Suite B, 2372 S.E. Bristol, Newport Beach, CA, 92660-0755, US

(21) Appl. No.: 09/849,046

(22) Filed: May 4, 2001

Related U.S. Application Data
(63) Continuation of application No. 09/764,533, filed on Jan. 16, 2001, now abandoned.

(51) Int. Cl. F16J 15/02

(52) U.S. Cl. 277/637

(57) ABSTRACT

A seal is provided for a well plate having a plurality of wells with each well having an opening in one end therein for influxing a fluid and another end thereof for effluxing the fluid. The seal includes a planar member having a top and bottom and a plurality of recess formed in the top and a plurality of cups formed in the bottom. A plurality of recesses are uniformly spaced apart from one another and each recess is sized for sealably engaging a corresponding well tip. The plurality of cups are uniformly spaced apart from another and sized for sealably engaging a corresponding well opening in order to enable the member to effect a sealed engagement with all of the well openings or all of the well tips.

The present invention generally relates to multi-well plate and column arrays for use in the analysis of liquid and is more particularly directed to seals for such multi-well plates.

A variety of multi-well arrangements, generally fabricated according to standardized formats, are used in the analysis or assay for a great number of a small quantity of liquids. For example, a plate having 96 wells is a popular configuration. Plates of this type may include a separation medium for removing solid or particulate matter from a liquid by filtration or a chromatographic medium for selectively separating, or indicating, a particular characteristic of a fluid being assayed.

A typical prior art solid phase extraction assembly is described in U.S. Pat. No. 5,906,796 to Blevins and Schultheis. The multi-well plate described in the referenced patent typically includes 96 wells arranged in rows and columns in which a solid phase extraction medium is placed and sequentially treated with liquid reagents and washes involved in an assay of interest.

It should be appreciated that this type of multi-well plate has dimensions in the order of 3 inches by 5 inches, and accordingly, a 96 well, or compartment, assay plate has a very small compartment dimension. Allowing for supporting well structure, in a typical 96 well plate, having wells arranged in a typical 8×12 configuration will have well diameters in the order of 0.3 inches.

It is important to keep the individual wells of a multi-well plate free of contamination prior to use, and further subsequent passage of liquid through the wells, the plates may be stored for later examination or assay. Consequently, there is a need for providing a seal for such multi-well plates which can be easily applied and removed.

The present invention provides a seal for a multi-well plate having a plurality of wells with each well having an opening on one end thereof for influxing a fluid and a type in another end thereof for effluxing the fluid.

### SUMMARY OF THE INVENTION

A seal for a multi-well plate in accordance with the present invention generally includes a planar member having a top and a bottom. A plurality of recesses are formed in the top of the member with the plurality of recesses being uniformly spaced apart from one another and each recess being sized for sealably engaging a corresponding well tip.

A plurality of cups are formed in the bottom of the member and sized for sealably engaging a corresponding well opening in order to enable the member to effect a sealed engagement with all of the well openings or all of the well tips.

Thin wall portions may be formed in the planar member between rows of cups for enabling the planar member to be divided along a thin wall portion. Thus, the planar member may be reduced in size in order to accommodate, or match, the number of wells actually used in a 96 well plate or other format.

More particularly, in accordance with the present invention, each of the recesses may include a bottom for sealably engaging the corresponding tip and a tapered sidewall for guiding the corresponding tip into the recess bottom.

This feature is important in enabling ready alignment and engagement of the seal with the multiple tips. Accordingly, multi-well plates of, for example 96 wells, may be rapidly and easily sealed individually by the facilitation of the tapered sidewalls in each of the recesses.

In addition, each of the plurality of cups include a body portion for sealably engaging the corresponding well opening and a tapered portion for guiding the corresponding well opening into the body portion. This enables rapid alignment of the member body portions with the well opening in a manner similar to the tapered sidewall function hereinabove described.

More particularly, each of the plurality of cups may be axially aligned with one of the plurality of recesses in order to enable a plurality of well plates to be stacked vertically.

A sealing system in accordance with the present invention for a plurality of well plates, such as those hereinabove described, includes a plurality of seals with each seal including a planar member having a top and a bottom and plurality of recesses formed in the member top which are uniformly spaced apart from one another and sized for sealably engaging a corresponding well tip.

A plurality of cups formed in the member bottom are provided and sized for sealably engaging a corresponding well opening in order to enable one of the plurality of seals to sealably engage all of the well opening of one plate and all of the well tips of another well plate. This features enables the sealing system in accordance with the present invention to enable a stacking of well plates.

Because the seal in accordance with the present invention may be used to seal either all of the well openings or all of the well tips or well plate, it should be appreciated that the inventory of such seals is significantly reduced and the necessity for selecting a coordinated seal dedicated to sealing either the well opening or the well tips is eliminated.

### BRIEF DESCRIPTION OF THE DRAWINGS

The advantages and features of the present invention will be better understood by the following description when considered in conjunction with the accompanying drawings in which:

FIG. 1 is a perspective view of two seals in accordance with the present invention positioned with respect to a multi-well plate in order to engage all of the wells of the plate and all of the tips of the plate;

FIG. 2 is a side view of a plurality of seals which form a system for sealing a plurality of multiwell plates in a stacked configuration;

FIG. 3 is a cross-sectional view taken along the line 3-3 of FIG. 2 showing a sealed engagement between the seal and multi-well plates; and

FIG. 4 is a perspective illustration of a seal, made in accordance with the present invention, being divided into two smaller seals.

### DETAILED DESCRIPTION

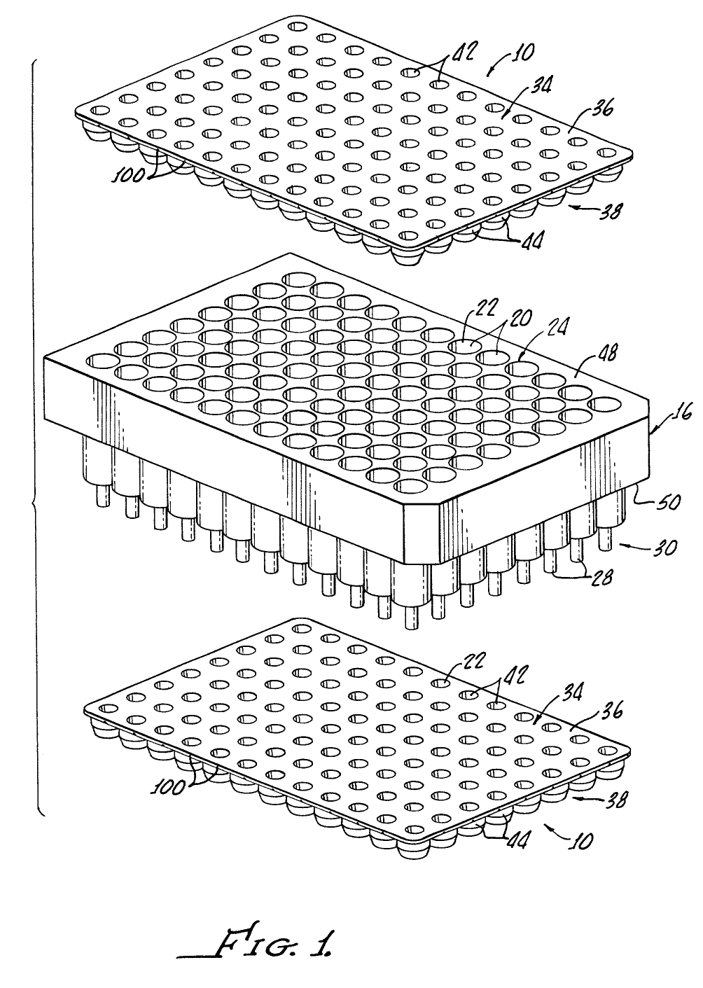

With reference to FIGS. 1 and 2, there is shown a seal 10 and sealing system 12 in accordance with the present invention for a plurality of multi-well plates 16.

Each of the plates 16 include a plurality of wells 20, for example 96 wells 20, with each well 20 having an opening 22 in one end 24 for influxing a fluid and a tip 28 in another end 30 of the well 20 for effluxing the fluid (not shown).

As shown, the seal system 12 includes a plurality of seals 10 with each of the seals 10 including a planar member 34 having a top 36 and a bottom 38. The member 34 may be formed from any suitable material such as, for example, by any conventional molding process.

As more clearly shown in FIG. 1 a plurality of recess 42 are formed in the member top 28 with the plurality of recess 42 being uniformly spaced apart from one another and each recess being sized for sealably engaging one of the well tips 28.

A plurality of cups 44 are formed in the member bottom 30 and sized for sealing one of the well openings 22. Because the member 34 includes the plurality of recesses 42 formed in the top 36 and a plurality of cups 44 are formed in the bottom 38, the member 34 can effect a sealed engagement with all of the well openings 22 or, alternatively, all of the well tips 28. Thus, the seal 10 may be utilized to seal either one side 48 of the plate 16 with well openings 22 or another side 50 with the tips 28 extending therefrom.

Exact vertical stacking of the plates 16 is enabled by an axial alignment of the plurality of tips 28 with the cups 44, such stacked relationship being illustrated in FIG. 2. Accordingly, the sealing system 12 in accordance with the present invention which includes a plurality of seals 10 enables a plurality of well plates 16 to be sealably stacked for storage either before or after use. Each of the recesses 42 (see FIG. 1) includes a bottom 56 for sealably engaging a tip 28 and a tapered sidewall 58 for aligning and guiding the 28 into the recess bottom 56. As hereinabove noted, this greatly facilitates the coupling of all of the recesses 42 with all of the tips 28 in a simultaneous manner. Thus, the difficulty in alignment of 96 separate tips 28 with 96 separate recesses is greatly facilitated by the tapered sidewalls 58.

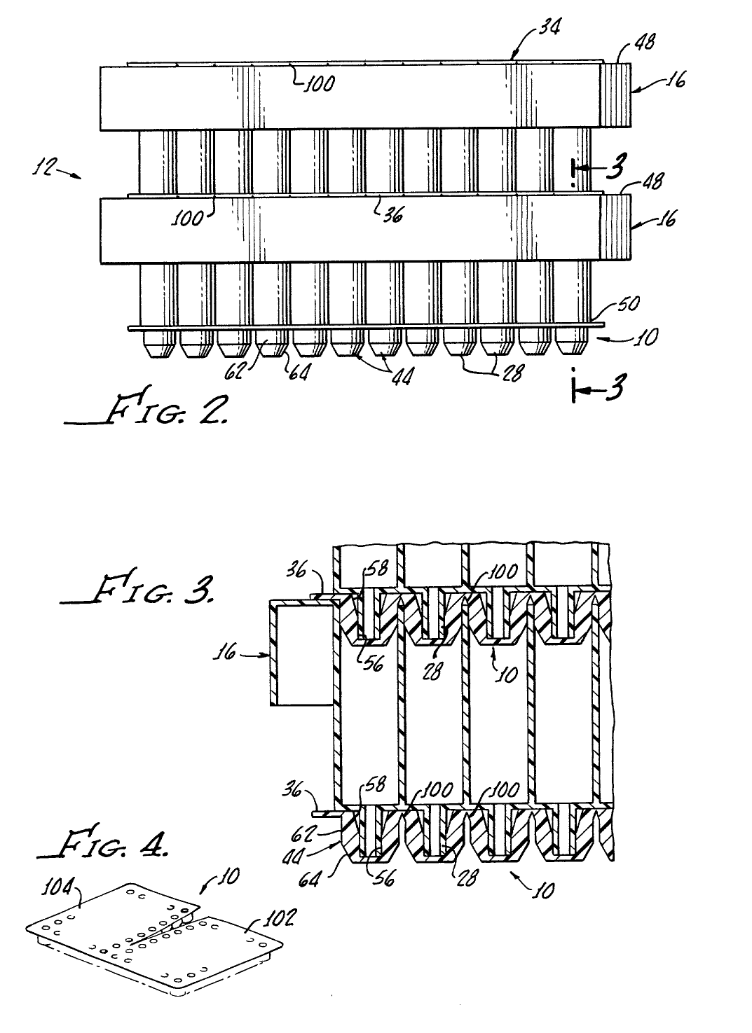

With reference to FIGS. 1 and 3, each of the cups 44 is formed with a body portion 62 for sealably engaging a well opening 22 and a tapered portion 64 for aligning and guiding the corresponding well opening 22 onto the body portion 62. This correspondingly facilitates the alignment and sealing of 96 well openings 22 by 96 cup body portions 62.

As shown in FIGS. 3 and 4, a thin wall portion 100 is formed between cups 44 for enabling, or facilitating, division of seal 10, planar member 34 into two smaller seals 102, 104. This may be done manually and enables the seal 10 to be utilized in sealing smaller multi-well plates, not shown. For example, the seal 10 may have 96 cups 44 and recesses 42 and may be divided into two seals 102, 104 for using 48 wells of the 96 well plate.

The ability to tear the plate seal 10 into smaller portions 102, 104 allows a user to use and seal a portion of the 96 well plate 16. Alternatively, a smaller portion 102, 104 may be used to seal a plate having only 8 columns (called octacolumns) (not shown) and 24 well plates (3 rows of 8) (not shown). Other formats (not shown) include well plates of 384 and 1536 wells. The larger plates (not shown) may be closed with multiple seals 10 in accordance with the present invention.

Although there has been hereinabove described a seal and seal system for multi-well plates in accordance with the present invention, for the purpose of illustrating the manner in which the invention may be used to advantage, it should be appreciated that the invention is not limited thereto. Accordingly, any and all modifications, variations or equivalent arrangements which may occur to those skilled in the art, should be considered to be within the scope of the present invention as defined in the appended claims.

What is claimed is:

1. A seal for a well plate having a plurality of wells, each well having an opening in one end thereof for influxing a fluid and a tip in another end thereof for effluxing the fluid, said seal comprising:
a planar member having a top and a bottom;
a plurality of recesses formed in said top, each recess being sized for sealably engaging a corresponding well tip; and
a plurality of cups formed in said bottom and sized for sealably engaging a corresponding well opening in order to enable the member to effect a sealed engagement with all of the well openings or all of the well tips.

2. The seal according to claim 1 wherein each of said plurality of recesses includes a bottom for sealably engaging the corresponding tip and a tapered sidewall for guiding the corresponding tip into the recess bottom;

3. The seal according to claim 1 wherein each of said plurality of cups include a body portion for sealably engaging the corresponding well opening and a tapered portion for guiding the corresponding well opening onto said body portion.

4. The seal according to claim 2 wherein each of said plurality of cups include a body portion for sealably engaging the corresponding well opening and a tapered portion for guiding the corresponding well opening onto said body portion.

5. The seal according to claim 1 wherein each of said plurality of cups is axially aligned with one of said plurality of recesses.

6. The seal according to claim 1 further comprising thin wall portions formed in said planar member between rows of cups for enabling the planar member to be divided along the thin wall portions.

7. A sealing system for a plurality of well plates, each well plate having a plurality of wells, each well having an opening in one end thereof for influxing a fluid and a tip in another end thereof effluxing the fluid, said sealing system comprising a plurality of seals, each seal comprising:
a planar member having a top and a bottom;
a plurality of recesses formed in said top, each recess being sized for sealably engaging a corresponding well tip; and
a plurality of cups formed in said bottom and sized for sealably engaging a corresponding well opening in order to enable one of said plurality of seals to sealably engage all of the well openings on one well plate and all of the well tips of another well plate.

8. The sealing system according to claim 7 wherein each of said plurality of cups is axially aligned with one of said plurality of recesses to enable vertically sealed stacking of said plurality of well plates.

9. The sealing system according to claim 7 wherein each of said plurality of recesses includes a bottom for sealably engaging the corresponding tip and a tapered sidewall for guiding the corresponding tip into the recess bottom.

10. The sealing system according to claim 7 wherein each of said plurality of cups include a body portion for sealably engaging the corresponding well opening and a tapered portion for guiding the corresponding well opening onto said body portion.

11. The sealing system according to claim 10 wherein each of said plurality of cups include a body portion for sealably engaging the corresponding well opening and a tapered portion for guiding the corresponding well opening onto said body portion.

12. The seal according to claim 7 further comprising thin wall portions formed in said planar member between rows of cups for enabling the planar member to be torn along the thin wall portions.

13. A sealing system for a plurality of well plates, each well plate having a plurality of wells, each well having an opening in one end thereof for influxing a fluid and a tip in another end thereof for effluxing the fluid, said sealing system comprising a plurality of seals, each comprising:
a planar member having a tip and a bottom;
a plurality of recesses formed in said top, each recess being sized for sealably engaging a corresponding well tip; and
a plurality of cups formed in said bottom and sized for sealably engaging a corresponding well opening in order to enable said plurality of well plates to be sealably stacked with one of said plurality of seals between two of said plurality of well plates.

14. The sealing system according to claim 13 wherein each of said plurality of cups is axially aligned with one of said plurality of recesses to enable vertical sealed stretching of said plurality of well plates.

15. The sealing system according to claim 13 wherein each of said plurality of recesses includes a bottom for sealably engaging the corresponding tip and a tapered sidewall for guiding the corresponding tip into the recess bottom.

16. The sealing system according to claim 13 wherein each of said plurality of cups include a body portion for sealably engaging the corresponding well opening and a tapered portion for guiding the corresponding well opening onto said body portion.

17. The sealing system according to claim 16 wherein each of said plurality of cups include a body portion for sealably engaging the corresponding well opening and a tapered portion for guiding the corresponding well opening onto said body portion.

18. A seal for a well plate having up to 96 wells, each well having an opening in one end thereof for influxing a fluid and a tip in another end thereof for effluxing the fluid, said seal comprising:
a planar member having a top and a bottom;
a plurality of recesses formed in said top, each recess being sized for sealably engaging a corresponding well tip;
a plurality of cups formed in said bottom and sized for sealably engaging a corresponding well opening in order to enable the member to effect a sealed engagement with all of the sell openings or all of the well tips; and
thin wall portions formed in said planar member between rows of cups for enabling manual separation of a smaller planar member from said planer member having a smaller plurality of recesses and cups, said smaller plurality being less than 96.
